(19) United States
(12) Patent Application Publication
(10) Pub. No.: US 2017/0206315 A1
(43) Pub. Date: Jul. 20, 2017

(54) ANALYSIS METHOD AND INFORMATION PROCESSING DEVICE

(71) Applicant: FUJITSU LIMITED, Kawasaki-shi (JP)

(72) Inventor: Tadaaki Katsuda, Bunkyo (JP)

(73) Assignee: FUJITSU LIMITED, Kawasaki-shi (JP)

(21) Appl. No.: 15/404,353

(22) Filed: Jan. 12, 2017

(30) Foreign Application Priority Data
Jan. 14, 2016 (JP) 2016-005384

(51) Int. Cl. G06F 19/28; G06F 17/30

(52) U.S. Cl. CPC G06F 19/28; G06F 17/30598; G06F 17/30554

(57) ABSTRACT

An information processing device includes a processor coupled to the memory and configured to classify multiple sets of gene information of each of a plurality of patients into a first group similar to a single set of target gene information or second group dissimilar to the single set of target gene information, the multiple sets of gene information and the single set of target gene information indicating expression levels of multiple genes, compare first gene information in the first group and second gene information in the second group, by testing, for each gene, whether a change in expression level is present or absent based on a comparison result, identify differentially expressed genes in which the change in the expression level is present, execute a pathway analysis to specify pathways in decreasing order of a number of the identified differentially expressed genes included in each pathway, and display a result.

### CROSS-REFERENCE TO RELATED APPLICATION

This application is based upon and claims the benefit of priority of the prior Japanese Patent Application No. 2016-005384, filed on Jan. 14, 2016, the entire contents of which are incorporated herein by reference.

### FIELD

The embodiments discussed herein are related to a technique for analyzing a pathway.

### BACKGROUND

In recent years, in the field of genome research, development of new medications, and so forth, a pathway analysis has been being carried out in which a pathway representing interaction among genes and proteins as a path diagram is used and a pathway including many differentially expressed gene groups in which an expression increases or decreases in response to a conditioned stimulus is examined.

The following technique or the like has been proposed. In the technique, genes are collected from test bodies and the expression levels of the genes are measured. Then, one or more are selected from the measured genes and a multivariate analysis is carried out about the selected gene. Furthermore, based on the result of the analysis, the state of a cancer is predicted from a classification result obtained by classifying the test bodies into groups in each of which the expression pattern of the genes is similar.

For example, related arts are disclosed in International Publication Pamphlet No. WO 2002/072828 and Japanese Laid-open Patent Publication No. 2014-75995.

### SUMMARY

According to an aspect of the embodiments, an information processing device includes a memory configured to store multiple sets of gene information of each of a plurality of patients, the multiple sets of gene information each indicating expression levels of multiple genes respectively, and a processor coupled to the memory and configured to classify the multiple sets of gene information into a first group similar to a single set of target gene information or second group dissimilar to the single set of target gene information, the single set of target gene information indicating expression levels of multiple genes and being acquired from a selected target patient, compare first gene information classified into the first group and second gene information classified into the second group, by testing, for each gene, whether a change in expression level which exceeds an expression difference threshold is present or absent based on a comparison result of the first group relative to the second group, identify, based on the testing for each gene, differentially expressed genes in which the change in the expression level is present, execute a pathway analysis to specify pathways in decreasing order of a number of the identified differentially expressed genes included in each pathway, and cause a display device to display a result of the pathway analysis.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram for explaining outline of a system in a first embodiment;

FIG. 2 is a diagram illustrating a hardware configuration example in the first embodiment;

FIG. 3 is a diagram illustrating a functional configuration example of a server in the first embodiment;

FIG. 4 is a flowchart diagram for explaining processing in a server in the first embodiment;

FIG. 5 is a diagram illustrating an example of an input screen to which a user inputs target specifying information in the first embodiment;

FIG. 6 is a diagram illustrating an example of similarity calculation processing in the first embodiment;

FIG. 7 is a diagram for explaining case division processing in the first embodiment;

FIG. 8 is a diagram for explaining a method for determining whether change in expression level of a gene is present or absent in the first embodiment;

FIG. 9 is a diagram illustrating a data example of a test result in the first embodiment;

FIG. 10 is a diagram illustrating a data example of part of a pathway information database in the first embodiment;

FIG. 11 is a diagram illustrating a data example of a matrix in the first embodiment;

FIG. 12 is a diagram illustrating an example of a pathway analysis result in the first embodiment;

FIG. 13 is a diagram illustrating an example of an analysis result screen in the first embodiment;

FIG. 14 is a diagram illustrating a functional configuration example of a server in a second embodiment;

FIG. 15 is a flowchart diagram for explaining processing in a server in the second embodiment;

FIG. 16 is a diagram illustrating a data example of a medication database in the second embodiment; and

FIG. 17 is a diagram illustrating an example of an analysis result screen in the second embodiment.

### DESCRIPTION OF EMBODIMENTS

The multivariate analysis is one of statistical techniques for analyzing the relationship between the expression state of genes and disease by using gene expression level information obtained from plural samples at a lesion site. By obtaining the gene expression level regarding plural samples including cancer tissue and normal tissue, the multivariate analysis is used in the case of analyzing the correlation between the expression state of genes and the occurrence or reoccurrence of a cancer, or the like. Furthermore, various statistical test methods are used, including the multivariate analysis.

In the above-described technique, if an individual patient has only one sample and the gene expression level information of the sample, it is difficult to carry out a statistical test using plural samples of the individual patient and identify differentially expressed genes. For example, in this case, it is difficult to carry out the pathway analysis.

Therefore, in one aspect, the embodiments discussed herein intend to identify differentially expressed genes regarding one set of gene expression level information.

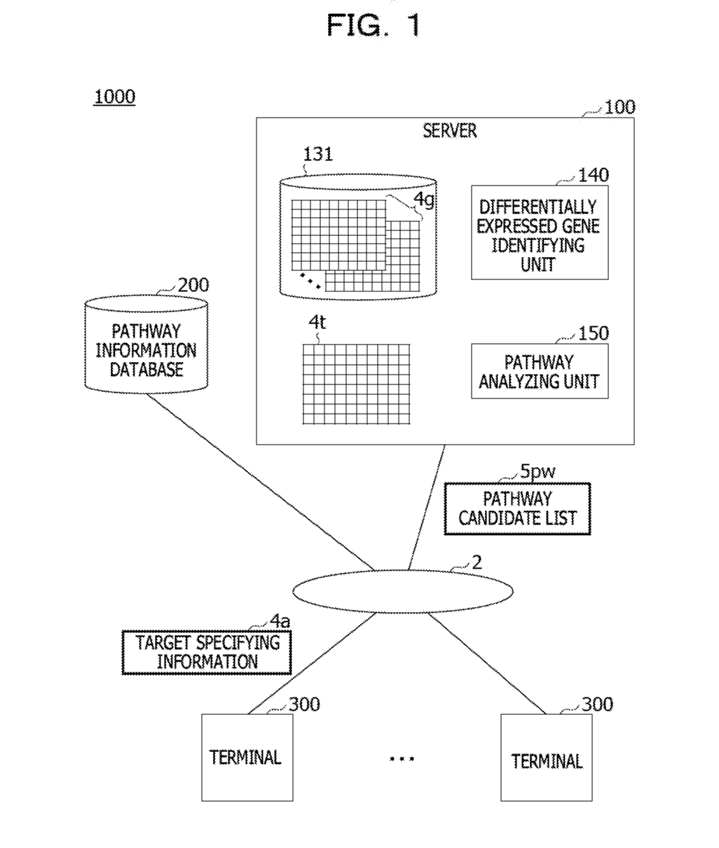

The embodiments will be described below based on the drawings. FIG. 1 is a diagram for explaining outline of a system in a first embodiment.

A system 1000 illustrated in FIG. 1 includes at least a server 100, a pathway information database 200, and one or plural terminals 300. The server 100 may be coupled to the pathway information database 200 with the intermediary of a network 2 and each terminal 300 is coupled to the server 100 with the intermediary of the network 2.

The server 100 is a server that allows the pathway analysis even for one set of target gene information 4t of one patient, and includes a differentially expressed gene identifying unit 140, a pathway analyzing unit 150, and a patient database 131. The detailed functional configuration of the server 100 will be described later.

The differentially expressed gene identifying unit 140 is a processing unit that identifies differentially expressed genes (DEG) based on the correlation between one set of target gene information 4t specified by target specifying information 4a received from the terminal 300 and multiple sets of gene information 4g of plural other patients. The pathway analysis is enabled by the identified differentially expressed genes.

The target specifying information 4a may include the target gene information 4t to become the target of a pathway analysis. Alternatively, the target specifying information 4a may specify one of one or more sets of target gene information 4t already held in the server 100. In this case, it suffices that the target gene information 4t is specified based on a patient identification (ID) or the like.

The pathway analyzing unit 150 is a processing unit that obtains, by a pathway analysis, one or plural pathway candidates having many differentially expressed genes identified by the differentially expressed gene identifying unit 140 and creates a pathway candidate list 5pw indicating the one or plural pathway candidates.

The pathway candidate list 5pw is transmitted to the terminal 300 as a reply to the target specifying information 4a.

The patient database 131 is a database that has already stored and managed multiple sets of gene information 4g of plural patients. The patient database 131 has at least one set of gene information 4g regarding each of patient IDs for identification of a patient and may include information on the past medical histories of the patients and so forth.

The pathway information database 200 is equivalent to a public database and it suffices that the pathway information database 200 is a public database arbitrarily selected in the system 1000.

The terminal 300 is a terminal used by a user of the system 1000. The user is a doctor, a researcher relating to the gene, a developer of a new medication, or the like.

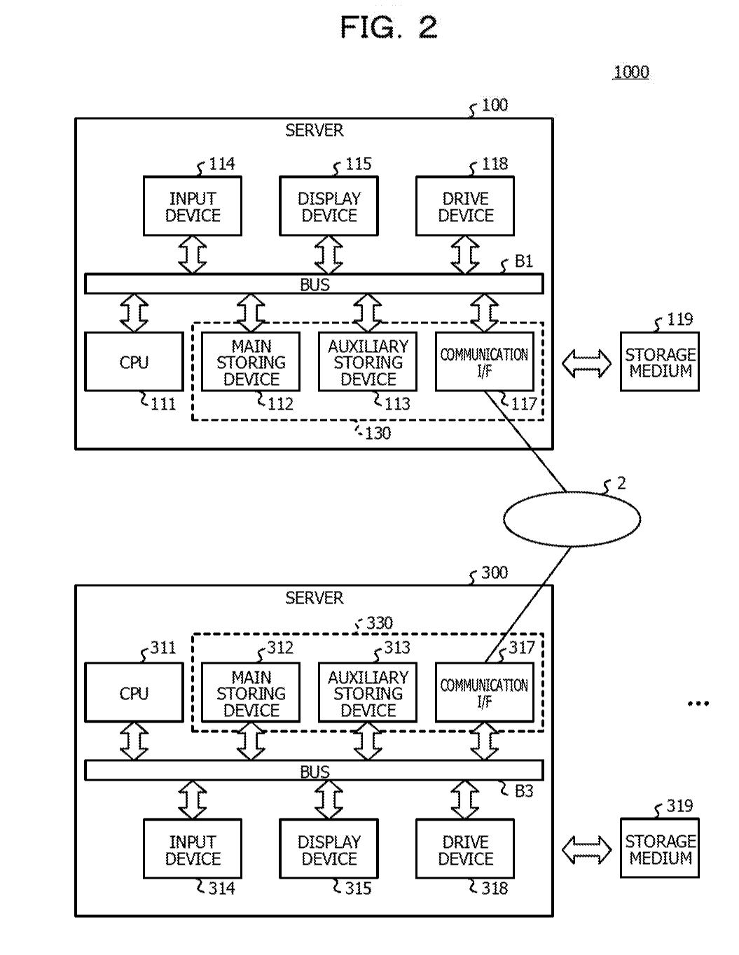

FIG. 2 is a diagram illustrating a hardware configuration example in the first embodiment. In FIG. 2, the server 100 is an information processing device controlled by a computer. The server 100 includes a central processing unit (CPU) 111, a main storing device 112, an auxiliary storing device 113, an input device 114, a display device 115, a communication interface (I/F) 117, and a drive device 118, and is coupled to a bus B1.

The CPU 111 is equivalent to a processor that controls the server 100 in accordance with a program stored in the main storing device 112. As the main storing device 112, a random access memory (RAM), a read only memory (ROM), and so forth are used. The main storing device 112 stores or temporarily saves the program to be executed in the CPU 111, data for processing in the CPU 111, data obtained in processing in the CPU 111, and so forth.

As the auxiliary storing device 113, a hard disk drive (HDD) or the like is used. The auxiliary storing device 113 stores data such as programs for execution of various kinds of processing. Part of the programs stored in the auxiliary storing device 113 is loaded into the main storing device 112 and is executed by the CPU 111, and thereby various kinds of processing are implemented. A storing unit 130 is equivalent to the main storing device 112 and the auxiliary storing device 113.

The input device 114 includes a mouse, a keyboard, and so forth and is used for input of various kinds of information for processing by the server 100 by an administrator of the system 1000. The display device 115 displays various kinds of information under control by the CPU 111.

The communication I/F 117 carries out communications through a wired or wireless network or the like. The communications by the communication I/F 117 are not limited to wireless or wired communications.

The program to implement processing executed by the server 100 is provided to the server 100 by a storage medium 119 such as a compact disc (CD)-ROM, for example.

The drive device 118 functions as an interface between the storage medium 119 (for example, CD-ROM or the like) set in the drive device 118 and the server 100.

Furthermore, a program to implement various kinds of processing to be described later according to the present embodiment is stored in the storage medium 119 and the program stored in the storage medium 119 is installed on the server 100 through the drive device 118. The installed program is executable by the server 100.

The storage medium 119 that stores the program is not limited to the CD-ROM and it suffices that the storage medium 119 is at least one non-transitory, tangible medium that is readable by a computer and has a structure. As the computer-readable storage medium, besides the CD-ROM, a portable recording medium such as a digital versatile disc (DVD) or a universal serial bus (USB) memory or a semiconductor memory such as a flash memory may be employed.

The terminal 300 is an information processing terminal controlled by a computer. The terminal 300 includes a CPU 311, a main storing device 312, an auxiliary storing device 313, an input device 314, a display device 315, a communication I/F 317, and a drive device 318, and is coupled to a bus B3.

The CPU 311 is equivalent to a processor that controls the terminal 300 in accordance with a program stored in the main storing device 312. As the main storing device 312, a RAM, a ROM, and so forth are used. The main storing device 312 stores or temporarily saves the program to be executed in the CPU 311, data for processing in the CPU 311, data obtained in processing in the CPU 311, and so forth.

As the auxiliary storing device 313, an HDD or the like is used. The auxiliary storing device 313 stores data such as programs for execution of various kinds of processing. Part of the programs stored in the auxiliary storing device 313 is loaded into the main storing device 312 and is executed by the CPU 311, and thereby various kinds of processing are implemented. A storing unit 330 is equivalent to the main storing device 312 and the auxiliary storing device 313.

The input device 314 includes a mouse, a keyboard, and so forth and is used for input of various kinds of information for processing by the server 100 by an administrator of the system 1000. The display device 315 displays various kinds of information under control by the CPU 311. The input device 314 and the display device 315 may be a user interface based on an integrated touch panel or the like.

The communication I/F 317 carries out communications through a wired or wireless network or the like. The communications by the communication I/F 317 are not limited to wireless or wired communications.

The program to implement processing executed by the terminal 300 is provided to the terminal 300 by a storage medium 319 such as a CD-ROM.

The drive device 318 functions as an interface between the storage medium 319 (for example, CD-ROM or the like) set in the drive device 318 and the terminal 300.

Furthermore, a program to implement various kinds of processing to be described later according to the present embodiment is stored in the storage medium 319 and the program stored in the storage medium 319 is installed on the terminal 300 through the drive device 318. The installed program is executable by the terminal 300.

The storage medium 319 that stores the program is not limited to the CD-ROM and it suffices that the storage medium 319 is at least one non-transitory, tangible medium that is readable by a computer and has a structure. As the computer-readable storage medium, besides the CD-ROM, a portable recording medium such as a DVD disc or a USB memory or a semiconductor memory such as a flash memory may be employed.

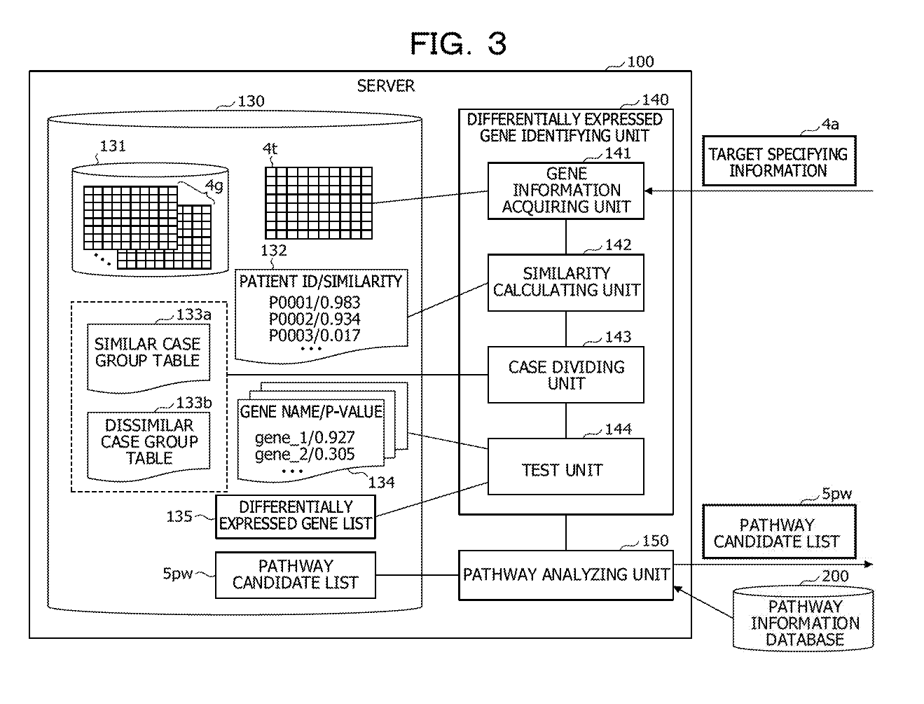

FIG. 3 is a diagram illustrating a functional configuration example of a server in the first embodiment. In FIG. 3, the server 100 mainly includes the differentially expressed gene identifying unit 140 and the pathway analyzing unit 150 as described above. The differentially expressed gene identifying unit 140 and the pathway analyzing unit 150 are implemented through execution of programs each corresponding to a respective one of the differentially expressed gene identifying unit 140 and the pathway analyzing unit 150 by the CPU 111 of the server 100.

Furthermore, the storing unit 130 stores the patient database 131, the target gene information 4t, a similarity calculation result 132, a similar case group table 133a, a dissimilar case group table 133b, a test result 134, a differentially expressed gene list 135, the pathway candidate list 5pw, and so forth.

The differentially expressed gene identifying unit 140 identifies differentially expressed genes based on the difference in the expression levels of genes between one set of target gene information 4t obtained from one sample of one patient and multiple sets of gene information 4g of plural other patients. One set of target gene information 4t is information indicating the expression level of each gene obtained from one deoxyribonucleic acid (DNA) probe.

The differentially expressed gene identifying unit 140 includes a gene information acquiring unit 141, a similarity calculating unit 142, a case dividing unit 143, and a test unit 144.

The gene information acquiring unit 141 acquires the target gene information 4t based on the target specifying information 4a received through the communication I/F 117. If the target specifying information 4a specifies a patient ID, the gene information acquiring unit 141 acquires the target gene information 4t from the patient database 131. If the target gene information 4t is included in the target specifying information 4a, the gene information acquiring unit 141 acquires the target gene information 4t from the received target specifying information 4a and stores the target gene information 4t in the storing unit 130. The patient ID or the patient in the target gene information 4t, specified by the target specifying information 4a, will be referred to as the target patient or selected patient hereinafter.

The similarity calculating unit 142 calculates similarities between the target patient of the target gene information 4t and the gene information 4g of the patients other than the target patient stored in the patient database 131. The similarity calculation result 132 is stored in the storing unit 130.

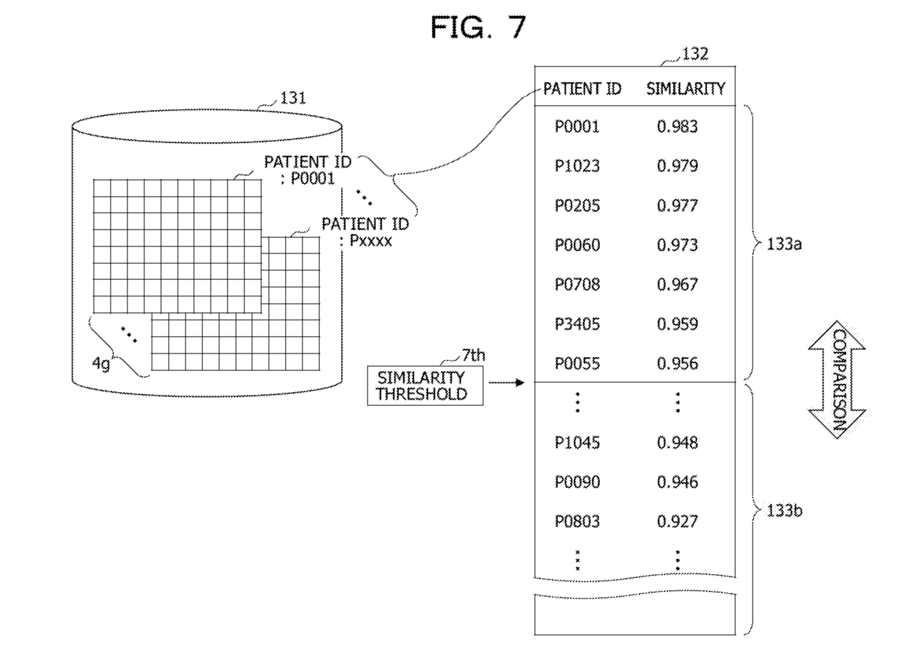

With use of the similarity calculation result 132 by the similarity calculating unit 142, the case dividing unit 143 classifies the patients that are registered in the patient database 131 and are compared with a case of the target patient into either a similar case group or a dissimilar case group based on a similarity threshold 7th (FIG. 7) obtained by being given. The similar case group table 133a indicates a list of the patient ID of the patients classified into the similar case group. The dissimilar case group table 133b indicates a list of the patient ID of the patients classified into the dissimilar case group. The similarity threshold 7th may be settable by a user.

The test unit 144 compares the gene information 4g of the patients in the similar case group and the gene information 4g of the patients in the dissimilar case group and acquires information about whether change in the expression is present or absent regarding each gene. Then, the test unit 144 carries out a two-group test. As one example of the two-group test, a case-control study may be used.

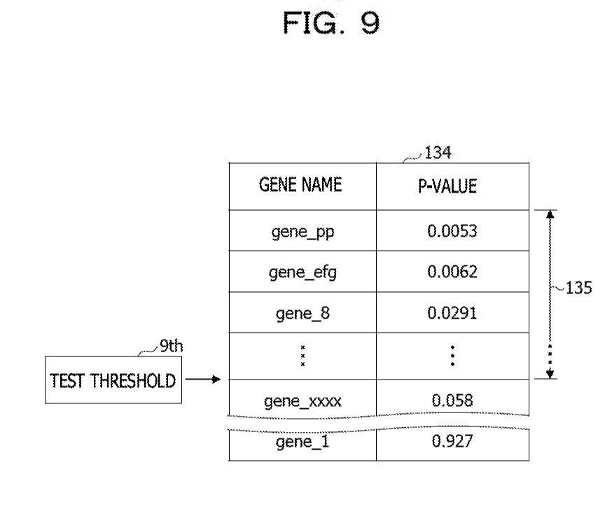

Then, the test unit 144 identifies differentially expressed genes in the target gene information 4t by using a test threshold 9th (FIG. 9) for the test result 134 by the test unit 144. The differentially expressed gene list 135 obtained by listing the gene names of the identified differentially expressed genes is stored in the storing unit 130. The test threshold 9th is a P-value serving as a basis for determining that the expression of a gene varies and may be settable by a user.

The pathway analyzing unit 150 is given, as an input, the differentially expressed gene list 135 stored in the storing unit 130 and searches the pathway information database 200 to acquire pathway candidates including many gene names indicated in the differentially expressed gene list 135. The pathway candidate list 5pw indicating the pathway candidates acquired by the pathway analyzing unit 150 is transmitted to the terminal 300 that is the transmission source of the target specifying information 4a.

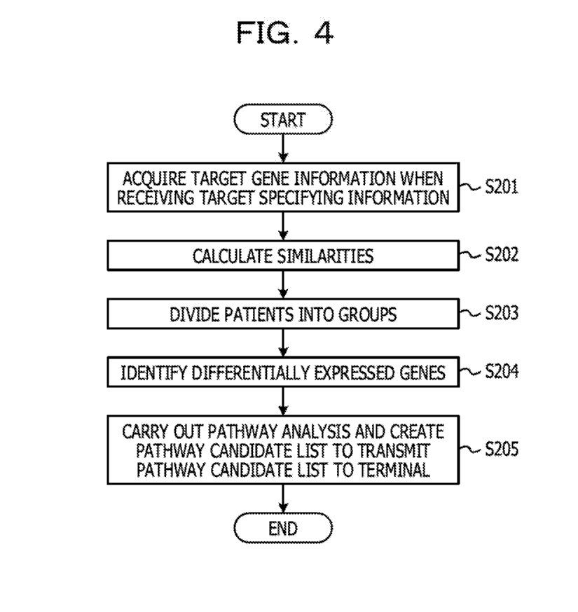

FIG. 4 is a flowchart diagram for explaining processing in a server in the first embodiment. In FIG. 4, in the server 100, when acquiring the target specifying information 4a from the terminal 300, the gene information acquiring unit 141 acquires the target gene information 4t (step S201).

If the target specifying information 4a includes the target gene information 4t, the gene information acquiring unit 141 acquires the target gene information 4t from the target specifying information 4a and stores the target gene information 4t in a work area of the storing unit 130. If the target specifying information 4a specifies a patient ID, the gene information acquiring unit 141 acquires the target gene information 4t from the patient database 131 and stores the target gene information 4t in a work area of the storing unit 130.

Then, the similarity calculating unit 142 executes similarity calculation processing of calculating similarities between the target gene information 4t and the gene information 4g of the patients other than the target patient held in the patient database 131 in a one-to-N relationship (step S202).

When the similarity calculation result 132 is output from the similarity calculating unit 142 to the storing unit 130, the case dividing unit 143 refers to the similarity calculation result 132 and executes case division processing of dividing the other patients into two groups by classifying the other patients into either a similar case group or a dissimilar case group based on the similarity threshold 7th (step S203). The similar case group table 133a in which the patients who belong to the similar case group are indicated as a list of the patient IDs and the dissimilar case group table 133b in which the patients who belong to the dissimilar case group are indicated as a list of the patient IDs are created.

Next, the test unit 144 compares the gene information 4g of the patients in the similar case group and the gene information 4g of the patients in the dissimilar case group and determines whether change in the expression is present or absent regarding each gene. Furthermore, the test unit 144 carries out a two-group test to identify differentially expressed genes (step S204).

The test unit 144 sequentially selects one patient ID-a listed in the similar case group table 133a and acquires the gene information 4g from the patient database 131 by using the selected patient ID-a. Next, the test unit 144 sequentially selects one patient ID-b listed in the dissimilar case group table 133b and acquires the gene information 4g from the patient database 131 by using the selected patient ID-b. The test unit 144 compares the two sets of gene information 4g of the patient ID-a and the patient ID-b and determines whether change in the expression is present or absent regarding each gene.

Regarding each of the patient IDs-a listed in the similar case group table 133a and each patient ID-b that belongs to the dissimilar case group table 133b, the determination of whether change in the expression is present or absent regarding each gene is carried out. The test unit 144 carries out the two-group test by using the determination result obtained in this manner. As one example of the two-group test, a case-control study may be used.

The test unit 144 sorts the P-value of each gene obtained by the two-group test in ascending order and identifies genes having a value smaller than the test threshold 9th as differentially expressed genes. It suffices that the test threshold 9th is a value with which 30 to 40 differentially expressed genes may be identified.

The test unit 144 creates the differentially expressed gene list 135 indicating the gene names of the plural identified differentially expressed genes and stores the differentially expressed gene list 135 in the storing unit 130.

Then, when the differentially expressed gene list 135 is input to the pathway analyzing unit 150, the pathway analyzing unit 150 carries out a pathway analysis and creates the pathway candidate list 5pw to transmit the pathway candidate list 5pw to the terminal 300 that is the transmission source of the target specifying information 4a (step S205). Thereafter, the processing in the server 100 in the first embodiment ends.

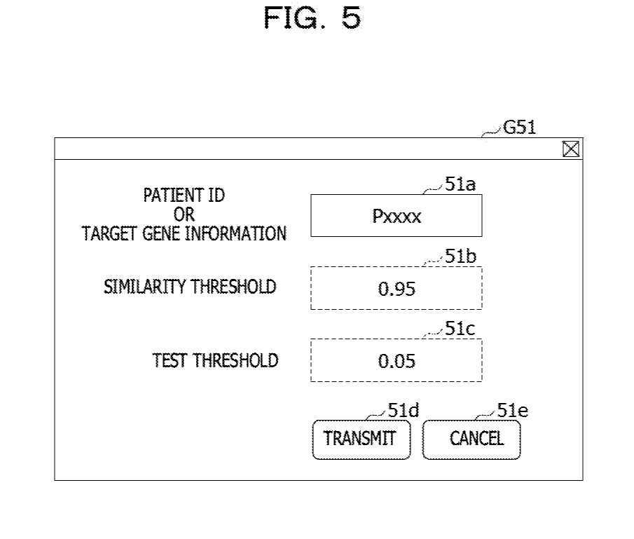

FIG. 5 is a diagram illustrating an example of an input screen to which a user inputs target specifying information in the first embodiment. In FIG. 5, an input screen G51 is a screen that is provided from the server 100 and is displayed on the terminal 300 and to which the target specifying information 4a is input. The input screen G51 includes an input area 51a to which a patient ID or the target gene information 4t is input, an input area 51b to which the similarity threshold 7th is input, an input area 51c to which the test threshold 9th is input, a transmission button 51d, and a cancel button 51e.

The input area 51a is an area to specify the patient ID or the file of the target gene information 4t. Reference from the input screen G51 to at least the patient ID among the items managed by the patient database 131 of the server 100 may be allowed, and selection of one patient ID by a user may be allowed. In this case, the server 100 may provide a list of the IDs of the patients about which only one set of target gene information 4t is held and cause a user to select the patient ID. Alternatively, the file of the target gene information 4t stored in the storing unit 330 of the terminal 300 may be specified.

The patient ID or the file of the target gene information 4t is information specific to a patient. Therefore, specifying either the patient ID or the file of the target gene information 4t is equivalent to selection of one patient by a user.

The similarity threshold 7th input to the input area 51b is a reference value for classification into the gene information 4g similar to the target gene information 4t selected by the user and the gene information 4g dissimilar to the target gene information 4t. A similarity closer to “1” indicates that the sets of gene information are more similar, and a similarity closer to “0” indicates that the sets of gene information are more dissimilar. A value close to “1” is set as the similarity threshold 7th. The input of the similarity threshold 7th is optional and may be omitted. If the input is omitted, a default value is employed.

The test threshold 9th input to the input area 51c is a reference value for the P-value indicating the probability of the hypothesis that change in the expression of a gene is present by the test. If the P-value is close to “0,” the P-value indicates that the hypothesis that change in the expression is present is probable, for example, indicates that the tested gene may be regarded as a differentially expressed gene. If the P-value is close to “1,” the P-value indicates that the hypothesis that change in the expression is present is discarded, for example, it is determined that the tested gene is not regarded as a differentially expressed gene. Therefore, a value close to “0” is set in the input area 51c. The input of the test threshold 9th is optional and may be omitted. If the input is omitted, a default value is employed.

The transmission button 51d is a button for transmitting the target specifying information 4a to the server 100. In the target specifying information 4a, at least the patient ID or the target gene information 4t is included. The target specifying information 4a further includes the similarity threshold 7th, the test threshold 9th, and so forth if input by a user is made.

The cancel button 51e is a button for canceling all of inputs by the user to the input screen G51.

When, with the terminal 300, a user inputs at least a patient ID or the target gene information 4t on the input screen G51 and presses down the transmission button 51d, the target specifying information 4a is transmitted to the server 100.

In this example, the target patient is specified by a patient ID “Pxxxx.” Furthermore, a similarity threshold “0.95” is specified and a test threshold “0.05” is specified. The target specifying information 4a that specifies the patient ID “Pxxxx,” the similarity threshold “0.95,” the test threshold “0.05,” and so forth is transmitted to the server 100.

In the server 100, when the target specifying information 4a is received through the communication I/F 117, the gene information acquiring unit 141 of the differentially expressed gene identifying unit 140 acquires, based on the target specifying information 4a, the target gene information 4t about which differentially expressed genes for carrying out a pathway analysis are identified.

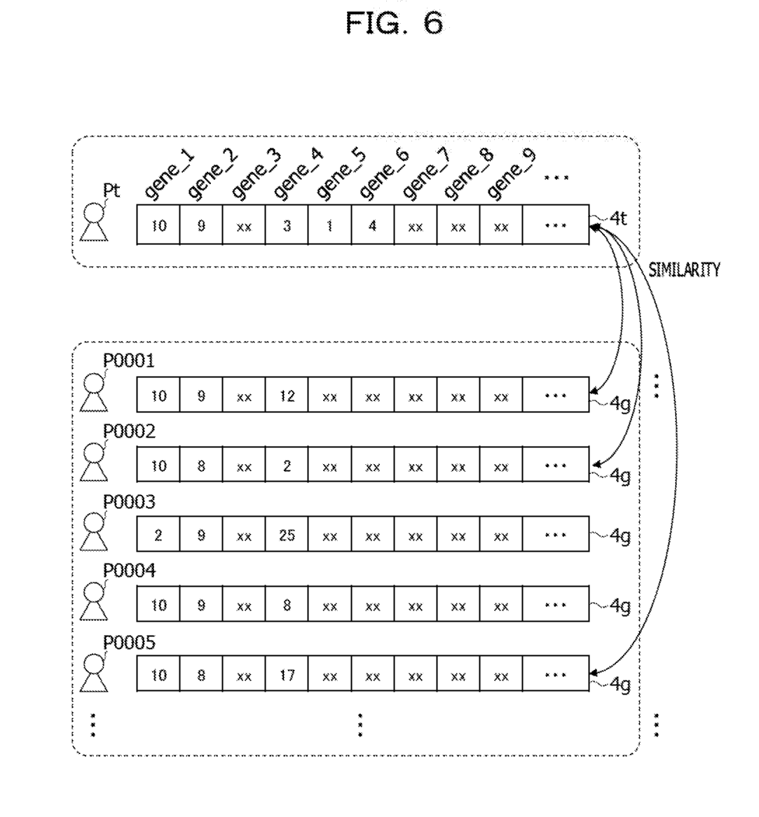

Then, the similarity calculation processing (step S202) by the similarity calculating unit 142 is executed. The similarity calculation processing will be described. FIG. 6 is a diagram illustrating an example of similarity calculation processing in the first embodiment. In FIG. 6, the patient identified by the patient ID “Pxxxx” is indicated by a target patient Pt and an example of the target gene information 4t identified by the patient ID “Pxxxx” is illustrated.

Furthermore, an example of the gene information 4g of each of the respective patient IDs “P0001,” . . . , “P0005,” . . . managed in the patient database 131 is illustrated. In both the target gene information 4t and the gene information 4g, the expression levels of the respective genes are indicated in order of gene name “gene_1,” . . . , “gene_9,” . . . .

In the similarity calculation processing by the similarity calculating unit 142, one set of target gene information 4t is compared with each of multiple sets of gene information 4g of plural patients other than the target patient Pt, and the similarities are calculated. The similarity calculation result 132 is output to the storing unit 130 and is stored.

Next, the case division processing by the case dividing unit 143 will be described. FIG. 7 is a diagram for explaining case division processing in the first embodiment. In FIG. 7, the similarity calculation result 132 is a table indicating the similarity of each patient and includes items of the patient ID, the similarity, and so forth.

The case dividing unit 143 sorts the similarity calculation result 132 stored in the storing unit 130 in decreasing order of the similarity. In FIG. 7, a data example of the similarity calculation result 132 after the sorting is illustrated. The leading patient ID “P0001” indicates a similarity “0.983,” which indicates that the patient of the patient ID is most similar to the target patient Pt. Furthermore, the patients of a patient ID “P1023” with a similarity “0.979,” a patient ID “P0205” with a similarity “0.977,” are similar to the target patient Pt in sequence.

The case dividing unit 143 extracts patient IDs each having a similarity equal to or higher than the similarity threshold 7th from the similarity calculation result 132 and creates the similar case group table 133a in the storing unit 130. Furthermore, the case dividing unit 143 extracts patient IDs each having a similarity lower than the similarity threshold 7th from the similarity calculation result 132 and creates the dissimilar case group table 133b in the storing unit 130.

As the similarity threshold 7th, the value specified in the target specifying information 4a is used with priority. If the similarity threshold 7th is not specified in the target specifying information 4a, a default value set in advance is employed.

A similar case group is identified by the similar case group table 133a and a dissimilar case group is identified by the dissimilar case group table 133b. The similar case group table 133a and the dissimilar case group table 133b are associated with the patient database 131 based on the patient ID. Sets of gene information 4g obtained from the patient database 131 by using the patient IDs included in the similar case group table 133a are referenced as plural sets of gene information 4g for the target patient Pt.

After the similar case group table 133a and the dissimilar case group table 133b are created, the test unit 144 tests the expression state of each gene. An example of test processing by the test unit 144 will be described.

In FIG. 7, the test unit 144 selects patient IDs from the similar case group table 133a and acquires the gene information 4g of the selected patient IDs and the gene information 4g of each patient ID indicated by the dissimilar case group table 133b from the patient database 131. Then, the test unit 144 determines whether or not change is present in the expression level regarding each gene. The determination of whether change in the expression level of the gene is present or absent will be described.

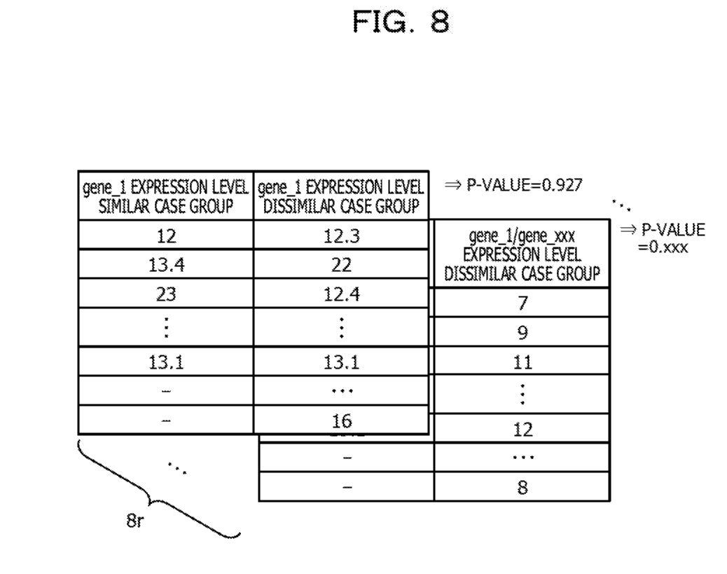

FIG. 8 is a diagram for explaining a method for determining whether change in expression level of a gene is present or absent in the first embodiment. Based on the similar case group table 133a and the dissimilar case group table 133b, the test unit 144 acquires, regarding each gene, a data set m of the expression level formed from the similar case group and a data set n of the expression level formed from the dissimilar case group from multiple sets of gene information 4g and determines whether or not change is present in the expression level.

In the example of FIG. 8, an example of a contrast table 8r in which the data set m and the data set n are contrasted on each gene basis is illustrated. The test unit 144 carries out a test based on a case-control study or the like on each gene basis by using the contrast table 8r and calculates the P-value. A P-value “0.927” is obtained regarding a gene “gene_1.” The P-value is obtained also regarding the other genes. Therefore, the test result 134 is output to the storing unit 130.

FIG. 9 is a diagram illustrating a data example of a test result in the first embodiment. In FIG. 9, the state in which the test result 134 has been sorted in increasing order of the P-value by the test unit 144 is illustrated.

The test unit 144 extracts gene names each having a P-value equal to or larger than the test threshold 9th from the test result 134 and creates the differentially expressed gene list 135 in the storing unit 130. As the test threshold 9th, the value specified in the target specifying information 4a is used with priority. If the test threshold 9th is not specified in the target specifying information 4a, a default value set in advance is employed.

In this example, the differentially expressed gene list 135 is created through extraction of gene names “gene_pp,” “gene_efg,” “gene_8,” and so forth from the test result 134. The differentially expressed gene list 135 created in the first embodiment indicates genes having a high possibility of the occurrence of variation in the expression level regarding the target patient Pt.

Due to the creation of the differentially expressed gene list 135 in this manner, plural differentially expressed genes may be identified and thus a pathway analysis may be carried out even when only one set of target gene information 4t exists regarding the target patient Pt.

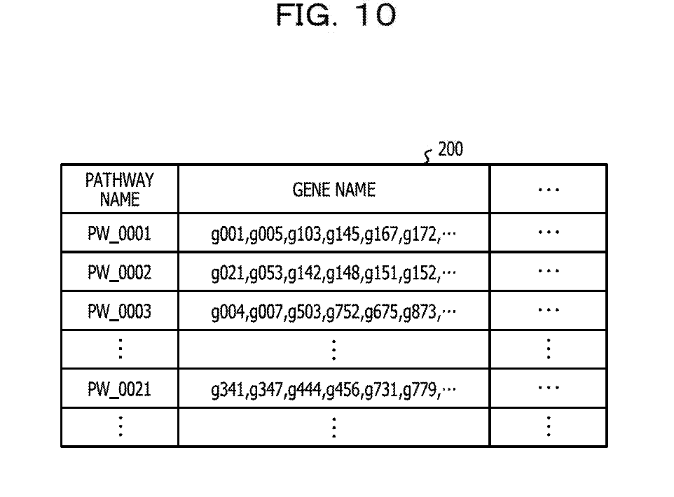

Prior to description of pathway analysis processing by the pathway analyzing unit 150, a data example is illustrated in FIG. 10 regarding a part according to the first embodiment obtained from the pathway information database 200.

FIG. 10 is a diagram illustrating a data example of part of a pathway information database in the first embodiment. In FIG. 10, the pathway information database 200 is a database indicating genes that appear in a pathway on each pathway basis and includes items of the pathway name, gene names, and so forth.

In this example, in the path that controls a life phenomenon identified by a pathway name “PW_0001,” genes “g001,” “g005,” “g103,” “g145,” “g167,” “g172,” and so forth appear through reference to the gene names.

In the path that controls a life phenomenon identified by a pathway name “PW_0002,” genes “g021,” “g053,” “g142,” “g148,” “g151,” “g152,” and so forth appear through reference to the gene names.

The pathway analyzing unit 150 identifies pathways including many gene names indicated by the differentially expressed gene list 135 from the pathway information database 200. For example, the pathway analyzing unit 150 acquires plural pathway names to identify the pathways deemed as the analysis target.

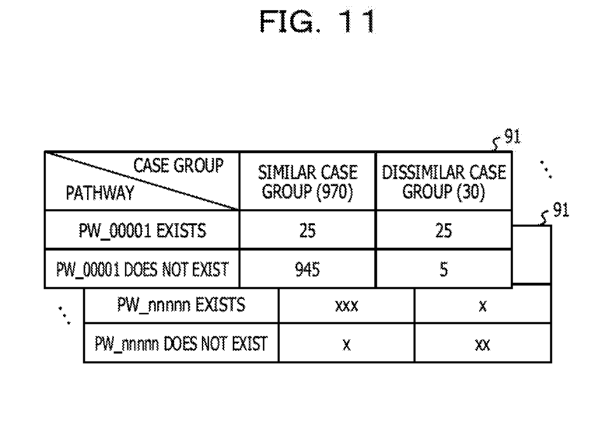

Regarding each pathway of the analysis target, statistical information on whether or not the pathway exists in each of the similar case group and the dissimilar case group is obtained. The statistical information may be represented by a matrix based on whether or not the pathway exists and the case groups like one illustrated in FIG. 11 on each pathway basis.

FIG. 11 is a diagram illustrating a data example of a matrix in the first embodiment. In FIG. 11, in each matrix 91, the number of sets of gene information 4g in which the pathway exists and the number of sets of gene information 4g in which the pathway does not exist are indicated in the similar case group. Furthermore, also in the dissimilar case group, the number of sets of gene information 4g in which the pathway exists and the number of sets of gene information 4g in which the pathway does not exist are indicated similarly. The number of sets of gene information 4g indicates, for example, the number of patients.

Suppose that, in this example, the number of patients who belong to the similar case group is “970” and the number of patients who belong to the dissimilar case group is “30” with respect to “1000” as the total number of patients. The number of patients who belong to the similar case group is equivalent to the number of records in the similar case group table 133a and the number of patients who belong to the dissimilar case group is equivalent to the number of records in the dissimilar case group table 133b.

Regarding the pathway “PW_0001,” in the similar case group, it is determined that 25 patients have a possibility of existence of the pathway “PW_0001,” and it is determined that 945 patients have a possibility of non-existence of the pathway “PW_0001.”

Meanwhile, in the dissimilar case group, it is determined that 25 patients have a possibility of existence of the pathway “PW_0001,” and it is determined that 5 patients have a possibility of non-existence of the pathway “PW_0001.” Regarding each pathway deemed as the analysis target, statistical information is indicated by a similar matrix 91 individually.

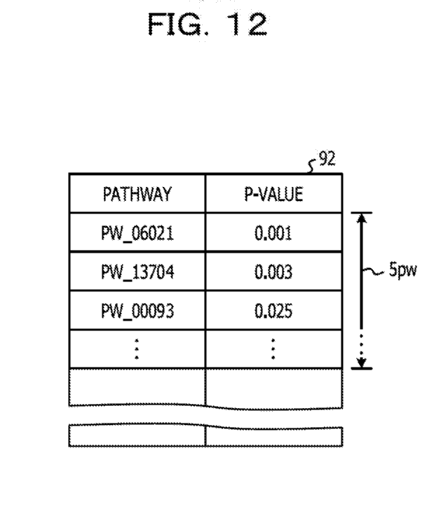

By using the matrix 91 of each pathway, the pathway analyzing unit 150 determines whether or not a significant difference is present in the existence and non-existence of the pathway between the similar case group and the dissimilar case group by a t-test, a chi-squared test, or the like. The P-value of each pathway is obtained. An example of the pathway analysis result in which the P-value is associated with each pathway is illustrated in FIG. 12.

FIG. 12 is a diagram illustrating an example of a pathway analysis result in the first embodiment. A pathway analysis result 92 illustrated in FIG. 12 is a list in which the P-value is indicated on each pathway basis. The pathway analysis result 92 is sorted in increasing order of the P-value by the pathway analyzing unit 150.

In this data example, the pathway having the smallest P-value is “PW_06021” and the P-value of the pathway is “0.001.” Subsequently, a pathway “PW_13704” indicates a P-value “0.003” and the next pathway “PW_00093” indicates a P-value “0.025.” The pathways are indicated in order of the P-value.

The pathway analyzing unit 150 identifies the pathways “PW_06021,” “PW_13704,” “PW_00093,” and so forth that each indicate a P-value equal to or smaller than a predefined reference value of the P-value and creates the pathway candidate list 5pw in the storing unit 130.

The pathway analyzing unit 150 transmits the created pathway candidate list 5pw to the terminal 300. The terminal 300 causes the display device 315 to display the received pathway candidate list 5pw.

Here, simply the pathway candidate list 5pw may be provided to the terminal 300. However, differentially expressed genes predicted regarding the target gene information 4t of the target patient Pt may be additionally transmitted.

The pathway analyzing unit 150 acquires a list of gene names from the pathway information database 200 based on the respective pathway names of the pathway candidate list 5pw and identifies genes included in the pathways by comparing the acquired list with the differentially expressed gene list 135 relating to the target patient Pt.

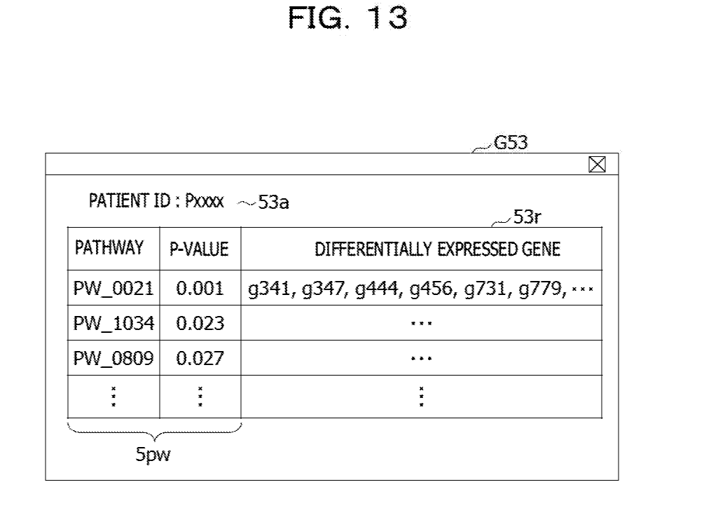

An analysis result screen GS53 that represents a pathway analysis result 53r of the target patient Pt, like one illustrated in FIG. 13, in which the pathway, the P-value, and differentially expressed genes are associated with each other may be transmitted to the terminal 300.

FIG. 13 is a diagram illustrating an example of an analysis result screen in the first embodiment. In FIG. 13, the analysis result screen G53 displayed on the display device 315 of the terminal 300 displays patient identifying information 53a to identify the patient, the pathway analysis result 53r, and so forth.

The patient identifying information 53a indicates the patient ID and/or the patient name of the target patient Pt. The pathway analysis result 53r is a table obtained by adding the differentially expressed genes to the pathway candidate list 5pw.

As above, the user may come to know pathway candidates relating to the disease state of the target patient Pt by only specifying the patient ID of a patient having one set of target gene information 4t or the entity of one set of target gene information 4t from the terminal 300.

In the pathway analysis result 53r, the P-value is indicated on each pathway basis. This may represent how much each pathway candidate correlates with the disease state of the target patient Pt. The user may understand the difference in the strength of the correlation between the pathway candidate having the highest correlation and the other pathway candidates and thus guess the disease state of the target patient Pt with higher accuracy.

In this example, among the plural pathway candidates indicated in the pathway candidate list 5pw, a pathway “PW_0021” having the smallest P-value is considered to be the pathway whose correlation with the disease state of the target patient Pt is strong. Furthermore, it is indicated that the strength of the correlation is in order of a pathway “PW_1034” with a P-value “0.023,” a pathway “PW_0809” with a P-value “0.027,” . . . .

A difference of “0.022” exists between the P-value “0.001” of the pathway “PW_0021” and the P-value “0.023” of the next pathway “PW_1034.” A difference of “0.004” exists between the P-value “0.023” of the pathway “PW_1034” and the P-value “0.027” of the next pathway “PW_0809.”

From this fact, it may be considered that the pathway “PW_0021” with the P-value “0.001” represents the disease state of the target patient Pt most appropriately compared with the other pathway candidates. As above, in the first embodiment, by utilizing the gene information 4g of the group of the case similar to the case of the target patient Pt and the dissimilar case group, a pathway analysis may be carried out for the target patient Pt and pathway candidates relating to the disease state of the target patient Pt may be obtained.

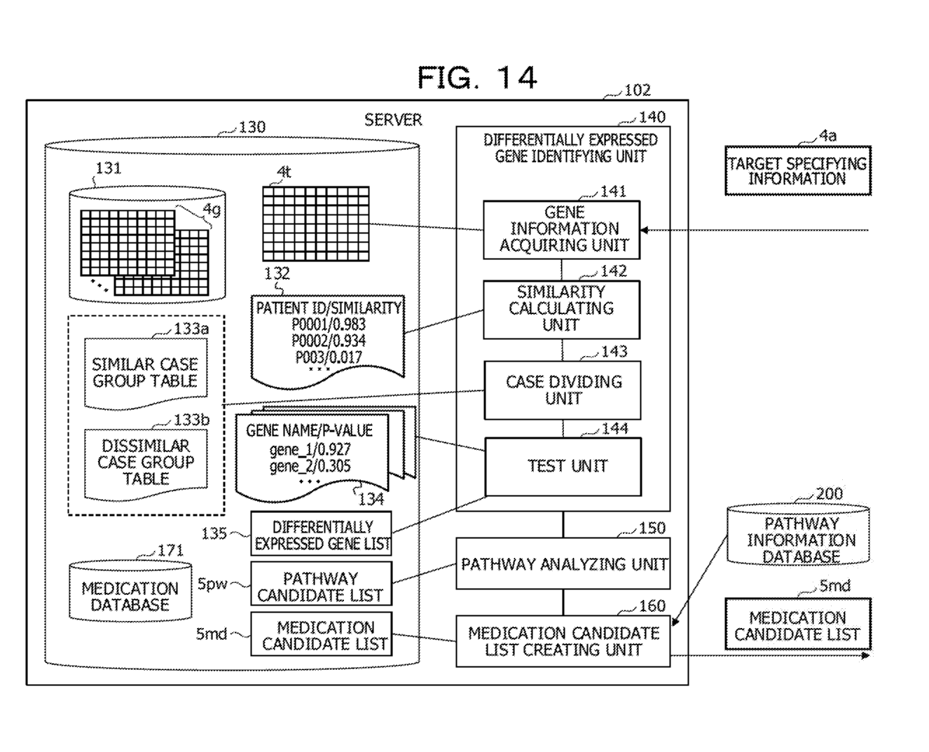

Next, a second embodiment will be described in which a medication candidate list 5md (FIG. 14) in which one or more medication candidates are associated with each pathway candidate is provided to the terminal 300. The configuration of the system in the second embodiment is similarly to the system 1000 of the first embodiment and therefore description of the system in the second embodiment is omitted. Furthermore, the hardware configuration in the second embodiment is also similarly to the first embodiment and therefore description of the hardware configuration in the second embodiment is omitted. In the second embodiment, the similar configuration as the first embodiment is given the same symbols and description of the configuration in the second embodiment is omitted.

FIG. 14 is a diagram illustrating a functional configuration example of a server in the second embodiment. In FIG. 14, a server 102 mainly includes the differentially expressed gene identifying unit 140, the pathway analyzing unit 150, and a medication candidate list creating unit 160 as described above. The differentially expressed gene identifying unit 140, the pathway analyzing unit 150, and the medication candidate list creating unit 160 are implemented through execution of programs each corresponding to a respective one of the differentially expressed gene identifying unit 140, the pathway analyzing unit 150, and the medication candidate list creating unit 160 by the CPU 111.

The server 102 in the second embodiment is different from the server 100 of the first embodiment in that the server 102 further includes the medication candidate list creating unit 160 in addition to the functional configuration of the first embodiment.

Furthermore, the storing unit 130 stores the patient database 131, the target gene information 4t, the similarity calculation result 132, the similar case group table 133a, the dissimilar case group table 133b, the test result 134, the differentially expressed gene list 135, a medication database 171, the pathway candidate list 5pw, the medication candidate list 5md, and so forth. In the second embodiment, the storing unit 130 is different from the first embodiment in that the storing unit 130 further stores the medication database 171 and the medication candidate list 5md.

The medication candidate list creating unit 160 refers to the medication database 171 and creates the medication candidate list 5md in which medication candidates are associated with each of the pathways in the pathway candidate list 5pw created by the pathway analyzing unit 150. Then, the medication candidate list creating unit 160 transmits the medication candidate list 5md to the terminal 300.

The medication database 171 is a database in which one or more disease names and medications applied to the respective disease names are stored regarding each pathway.

The medication candidate list 5md is a table in which applied medication candidates are indicated regarding each of the pathways in the pathway candidate list 5pw. In the second embodiment, the medication candidates are equivalent to medication names selected based on cases similar to the case of the target patient Pt.

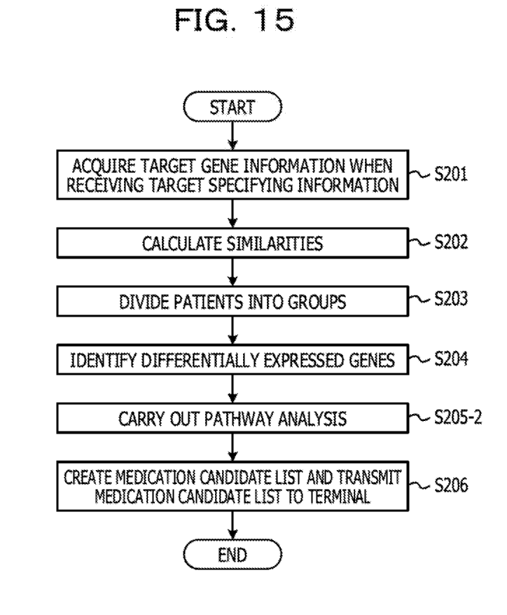

FIG. 15 is a flowchart diagram for explaining processing in a server in the second embodiment. In FIG. 15, processing from the steps S201 to S204 is similarly to the first embodiment and therefore description of the processing is omitted.

After differentially expressed genes of the target patient Pt are identified, the differentially expressed gene list 135 is input to the pathway analyzing unit 150 and a pathway analysis by the pathway analyzing unit 150 is carried out, so that the pathway candidate list 5pw is created (step S205-2).

In the second embodiment, medication candidate list creation processing by the medication candidate list creating unit 160 is further executed. The medication candidate list creating unit 160 refers to the medication database 171 and creates the medication candidate list 5md obtained by adding medication names corresponding to the respective pathways to the pathway candidate list 5pw. Then, the medication candidate list creating unit 160 transmits the medication candidate list 5md to the terminal 300 that is the transmission source of the target specifying information 4a (step S206). Thereafter, the processing in the server 102 ends.

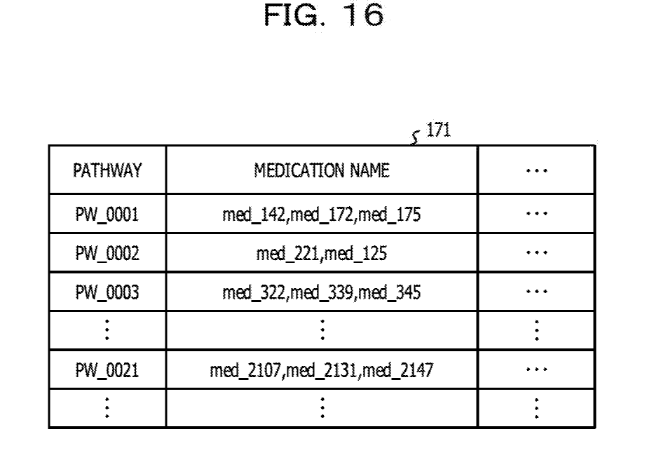

FIG. 16 is a diagram illustrating a data example of a medication database in the second embodiment. In FIG. 16, the medication database 171 is a database in which medication names are stored in association with each pathway, and includes items of the pathway, the medication name, and so forth.

The pathway indicates pathway names to identify pathways and so forth. It suffices for the pathway name to be a name registered in the pathway information database 200. The medication name indicates names to identify medications.

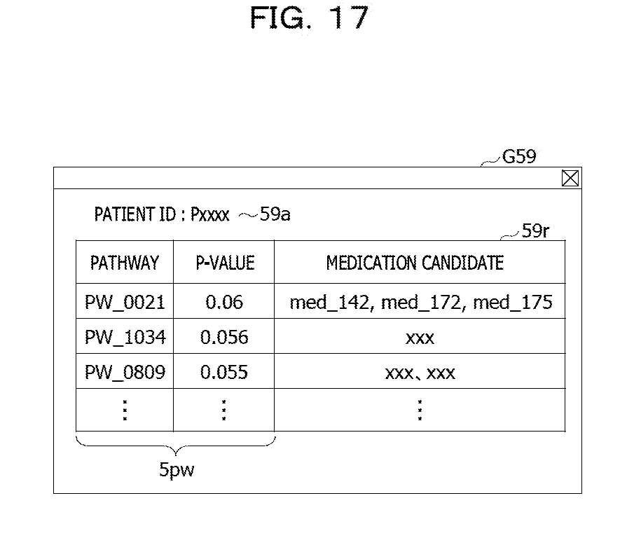

The medication candidate list 5md obtained through reference to the medication database 171 is displayed in an analysis result screen G59 like one illustrated in FIG. 17 on the display device 315 of the terminal 300.

FIG. 17 is a diagram illustrating an example of an analysis result screen in the second embodiment. In FIG. 17, the analysis result screen G59 displayed on the display device 315 of the terminal 300 displays patient identifying information 59a to identify the patient, a pathway analysis result 59r, and so forth.

The patient identifying information 59a indicates the patient ID and/or the patient name of the target patient Pt. The pathway analysis result 59r is a table obtained by adding the medication candidates to the pathway candidate list 5pw.

As above, the user may come to know pathway candidates relating to the disease state of the target patient Pt by only specifying the patient ID of a patient having one set of target gene information 4t or the entity of one set of target gene information 4t from the terminal 300.

In the pathway analysis result 59r, the P-value is indicated on each pathway basis. This may represent how much each pathway candidate correlates with the disease state of the target patient Pt. The user may understand the difference in the strength of the correlation between the pathway candidate having the highest correlation and the other pathway candidates and thus guess the disease state of the target patient Pt with higher accuracy.

In the example of the pathway candidate list 5pw, it may be considered that a pathway “PW_0021” with a P-value “0.06” represents the disease state of the target patient Pt most appropriately compared with the other pathway candidates similarly to the first embodiment. As above, also in the second embodiment, by utilizing the gene information 4g of the group of the case similar to the case of the target patient Pt and the dissimilar case group, a pathway analysis may be carried out for the target patient Pt and pathway candidates relating to the disease state of the target patient Pt may be obtained.

Moreover, in the pathway analysis result 59r in the second embodiment, one or more medication candidates are associated with each pathway candidate. This allows the user to select proper medications suitable for the disease state of the target patient Pt.

In the above-described first embodiment and second embodiment, a disease name predicted regarding the target patient Pt may be acquired from the user of the terminal 300 and the predicted disease name may be specified in the target specifying information 4a. Based on the disease name specified in the target specifying information 4a, the similar case group table 133a and the dissimilar case group table 133b may be created in such a manner that patients narrowed down by the gene information acquiring unit 141 are treated as the population with reference to the patient database 131. This may reduce the processing load of the differentially expressed gene identifying unit 140.

Techniques of the present disclosure are not limited to the embodiments disclosed, and various modifications and changes may be made without departing from the scope of claims.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing device comprising:
a memory configured to store multiple sets of gene information of each of a plurality of patients, the multiple sets of gene information each indicating expression levels of multiple genes respectively; and
a processor coupled to the memory and configured to:
classify the multiple sets of gene information into a first group similar to a single set of target gene information or second group dissimilar to the single set of target gene information, the single set of target gene information indicating expression levels of multiple genes and being acquired from a selected target patient,
compare first gene information classified into the first group and second gene information classified into the second group, by testing, for each gene, whether a change in expression level which exceeds an expression difference threshold is present or absent based on a comparison result of the first group relative to the second group,
identify, based on the testing for each gene, differentially expressed genes in which the change in the expression level is present,
execute a pathway analysis to specify pathways in decreasing order of a number of the identified differentially expressed genes included in each pathway, and
cause a display device to display a result of the pathway analysis.

2. The information processing device according to claim 1, wherein
the result of the pathway analysis includes one or more differentially expressed genes included in each of the specified pathways.

3. The information processing device according to claim 1, wherein
the memory is configured to store medication information that indicates one or more medications regarding each pathway, and
the result of the pathway analysis includes the one or more medications indicated regarding each of the specified pathways based on the medication information.

4. The information processing device according to claim 1, wherein
the processor is configured to determine whether the change in the expression level is present or absent regarding each gene by a two-group test.

5. The information processing device according to claim 1, wherein
the result of the pathway analysis includes a P-value corresponding to each pathway.

6. The information processing device according to claim 1, wherein the pathway analysis includes
determining whether each pathway exists or does not exist in both the first group and the second group, and
determining whether a specific difference is present between the existence and nonexistence of each pathway between the first group and the second group.

7. A method executed by a processor, the method comprising:
classifying multiple sets of gene information of each of a plurality of patients into a first group similar to a single set of target gene information or second group dissimilar to the single set of target gene information, the multiple sets of gene information each indicating expression levels of multiple genes respectively, and the single set of target gene information indicating expression levels of multiple genes and being acquired from a selected target patient;
comparing first gene information classified into the first group and second gene information classified into the second group, by testing, for each gene, whether a change in expression level which exceeds an expression difference threshold is present or absent based on a comparison result of the first group relative to the second group;
identifying, based on the testing for each gene, differentially expressed genes in which the change in the expression level is present;
executing a pathway analysis to specify pathways in decreasing order of a number of the identified differentially expressed genes included in each pathway; and
causing a display device to display a result of the pathway analysis.

8. The method according to claim 7, wherein
the result of the pathway analysis includes one or more differentially expressed genes included in each of the specified pathways.

9. The method according to claim 7, wherein
the result of the pathway analysis includes the one or more medications indicated regarding each of the specified pathways based on medication information that indicates one or more medications regarding each pathway

10. The method according to claim 7, further comprising:
determining whether the change in the expression level is present or absent regarding each gene by a two-group test.

11. The method according to claim 7, wherein
the result of the pathway analysis includes a P-value corresponding to each pathway.

12. The method according to claim 7, wherein the pathway analysis includes
determining whether each pathway exists or does not exist in both the first group and the second group, and
determining whether a specific difference is present between the existence and nonexistence of each pathway between the first group and the second group.

13. A non-transitory computer-readable storage medium storing a program which causes a processor to execute a procedure, the procedure comprising:
classifying multiple sets of gene information of each of a plurality of patients into a first group similar to a single set of target gene information or second group dissimilar to the single set of target gene information, the multiple sets of gene information each indicating expression levels of multiple genes respectively, and the single set of target gene information indicating expression levels of multiple genes and being acquired from a selected target patient;
comparing first gene information classified into the first group and second gene information classified into the second group, by testing, for each gene, whether a change in expression level which exceeds an expression difference threshold is present or absent based on a comparison result of the first group relative to the second group;
identifying, based on the testing for each gene, differentially expressed genes in which the change in the expression level is present;
executing a pathway analysis to specify pathways in decreasing order of a number of the identified differentially expressed genes included in each pathway; and
causing a display device to display a result of the pathway analysis.

14. The non-transitory computer-readable storage medium according to claim 13, wherein
the result of the pathway analysis includes one or more differentially expressed genes included in each of the specified pathways.

15. The non-transitory computer-readable storage medium according to claim 13, wherein
the result of the pathway analysis includes the one or more medications indicated regarding each of the specified pathways based on medication information that indicates one or more medications regarding each pathway

16. The non-transitory computer-readable storage medium according to claim 13, the procedure further comprising:
determining whether the change in the expression level is present or absent regarding each gene by a two-group test.

17. The non-transitory computer-readable storage medium according to claim 13, wherein
the result of the pathway analysis includes a P-value corresponding to each pathway.

18. The non-transitory computer-readable storage medium according to claim 13, wherein the pathway analysis includes
determining whether each pathway exists or does not exist in both the first group and the second group, and
determining whether a specific difference is present between the existence and nonexistence of each pathway between the first group and the second group.
